(19) United States
(12) Patent Application Publication
(10) Pub. No.: US 2006/0008140 A1
(43) Pub. Date: Jan. 12, 2006

(54) Segmentation technique of a color image according to colors

(75) Inventors: Atsushi Imamura, Kamikyo-ku (JP); Yasushi Nagata, Kamikyo-ku (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/124,119

(22) Filed: May 9, 2005

(30) Foreign Application Priority Data
Jul. 9, 2004 (JP) 2004-203413

(51) Int. Cl. G06K 9/00

(52) U.S. Cl. 382/164

(57) ABSTRACT

The present invention provides a technique to improve reliability of a segmentation result for a subject image, which is obtained a colored object with the possibility of change in color for each individual items. In a specified color space, existing color areas indicating ranges of colors containable in the subject image when the colored object has an allowable range of color, and non-existent color areas for outside the existing color areas are set. Then, subject image segmentation is performed by classifying colors of pixels of the subject image into the existing color areas and the non-existent color area.

### CROSS-REFERENCE TO RELATED APPLICATIONS

The present application claims the priority based on Japanese Patent Application No. 2004-203413 filed on Jul. 9, 2004, the disclosure of which is hereby incorporated herein by reference in its entirety.

### BACKGROUND OF THE INVENTION

1. Field of the Invention

The present invention relates to technique of area segmentation of a color image according to colors.

2. Description of the Related Art

An inspection apparatus such as a printed circuit board tester detects defect of a product subject to testing by comparing the color image of a product without a defect (hereafter also called a “reference image”) and a color image of the product subject to testing (hereafter also called a “subject image”). With some kind of inspection apparatus, to determine whether or not a particular object within the reference image corresponds to an object within the subject image, a plurality of representative colors representing colors of the particular object within the reference image are set, and area segmentation of the subject image is performed whereby subject images are divided into areas corresponding to representative colors.

When area segmentation of subject images is performed using this kind of area division method, the colors of objects within a subject image are classified into one of the representative colors. Because of this, even if there is a defect that gives a different color from the representative color to the testing subject, according to that color, area segmentation is performed as an object without defects, and it is possible that defect may not be detected. This kind of problem is pronounced for inspection apparatus that perform color image segmentation, but generally, when there is the possibility of appearance of a color not expected to appear in the subject image in a color image subject to segmentation, the reliability of the segmentation results decreases, and there is a risk of having segmentation results that are different from the desired segmentation.

### SUMMARY OF THE INVENTION

An object of the present invention is to improve reliability of a segmentation result for a subject image with the possibility of appearance of a color not expected to appear in the subject image.

According to an aspect of the present invention, a method of a subject image segmentation wherein the subject image is a color image obtained by imaging a colored object with possibility of change in color for each individual item is provided. The method comprises the steps of: (a) setting N existing color areas indicating ranges of N colors containable in the subject image when the colored object has an allowable range of color, and a non-existent color area outside the N existing color areas, within a specified color space, N being an integer of 2 or more; and (b) dividing the subject image into areas by classifying colors of subject pixels that form the subject image obtained by imaging each of the colored object into the N existing color areas and the non-existent color area.

With this arrangement, it is possible to classify colors which are not expected to appear in the subject image as non-existent color areas, allowing improvement in the reliability of color image area division.

The present invention may be realized in various aspects, and for example, may be realized with aspects such as a color image segmentation method and device, an inspection method and device using these segmentation results, a method and device for generating lookup tables used for color image segmentation, a computer program for realizing the functions of these types of methods and devices, a recording medium on which that computer program is recorded, data signals embodied within carrier waves including that computer program, and the like.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates the configuration of a printed circuit board tester 100 as an embodiment of the present invention.

FIG. 2 is a flow chart showing the procedure for image processing (pre-processing) performed by the pre-processing unit for the first embodiment.

FIG. 3 depicts a color image of the printed circuit board PCB without defect acquired at step S200.

FIG. 4 illustrates the way of setting of the representative colors.

FIG. 5 illustrates the division result of a color space into representative color areas.

FIG. 6 illustrates the setting result of the existing color area for the first embodiment.

FIG. 7 is a flow chart showing the procedure of the image process (actual process) by the actual processing unit for the first embodiment.

FIG. 8 depicts an example of the color image of the printed circuit board PCB with a defect acquired at step S300.

FIG. 9A illustrates distribution of color of pixels in the image of the printed circuit board PCB with a defect shown in FIG. 8.

FIG. 9B depicts segmentation result of the color image of the printed circuit board PCB shown in FIG. 8.

FIG. 10 illustrates the setting result of the existing color area for a second embodiment

FIG. 11 is a flow chart showing the procedure of segmentation for the second embodiment.

FIG. 12 illustrates the setting result of the existing color area for a third embodiment.

FIG. 13A through FIG. 13C illustrate the division results of a color space into representative color areas used for setting of the existing color areas for a fourth embodiment.

FIG. 14 illustrates the setting result of the existing color areas using the three division results of a color space shown in FIG. 13A through FIG. 13C.

FIG. 15 illustrates the setting result of the existing color area for a fifth embodiment.

FIG. 16 is a flow chart showing the procedure for segmentation for the sixth embodiment.

### DESCRIPTION OF THE PREFERRED EMBODIMENT

Embodiments of the present invention will now be described in the following sequence.
A. First Embodiment:
B. Second Embodiment:
C. Third Embodiment:
D. Fourth Embodiment:
E. Fifth Embodiment:
F. Sixth Embodiment:
G. Variation Examples:

### A. First Embodiment

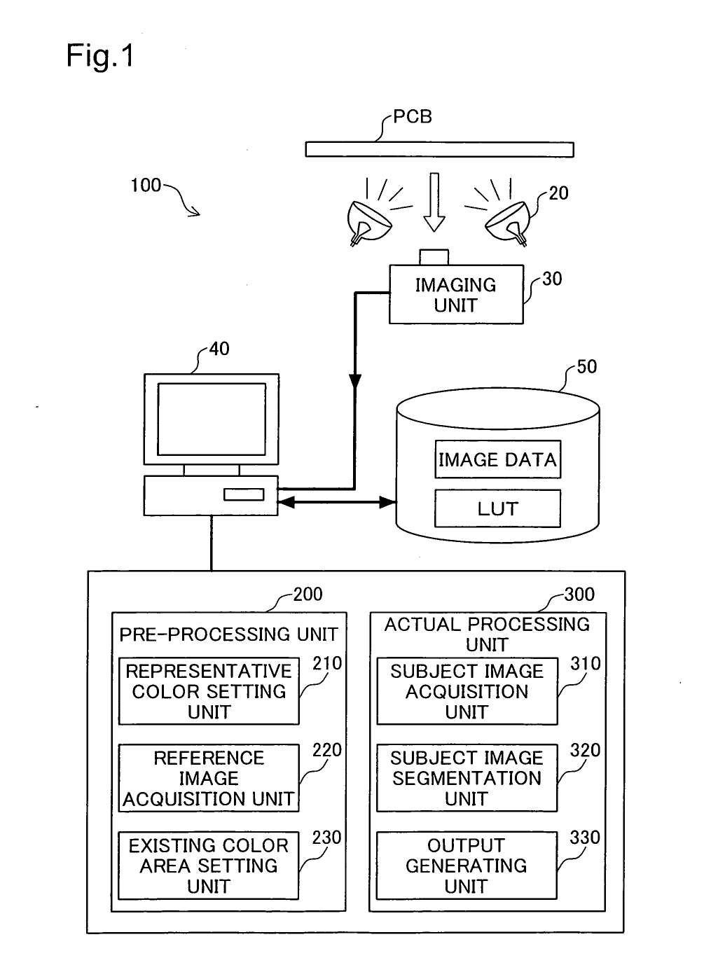

FIG. 1 illustrates the configuration of a printed circuit board tester 100 as an embodiment of the present invention. This printed circuit board tester 100 comprises a light source 200 for illuminating a printed circuit board PCB, an imaging unit 30 for capturing an image of the printed circuit board PCB, and a computer 40 for performing control of the overall device. An external storage device 50 for storing various types of data or computer programs is connected to the computer 40.

The computer 40 has the functions of a pre-processing unit 200 and an actual processing unit 300. The functions of these units are realized by the computer 40 executing the computer program stored in the external storage device 50.

The pre-processing unit 200 comprises a representative color setting unit 210, a reference image acquisition unit 220, and an existing color area setting unit 230. The actual processing unit 300 comprises a subject image acquisition unit 310, a subject image segmentation unit 320, and an output generating unit 330.

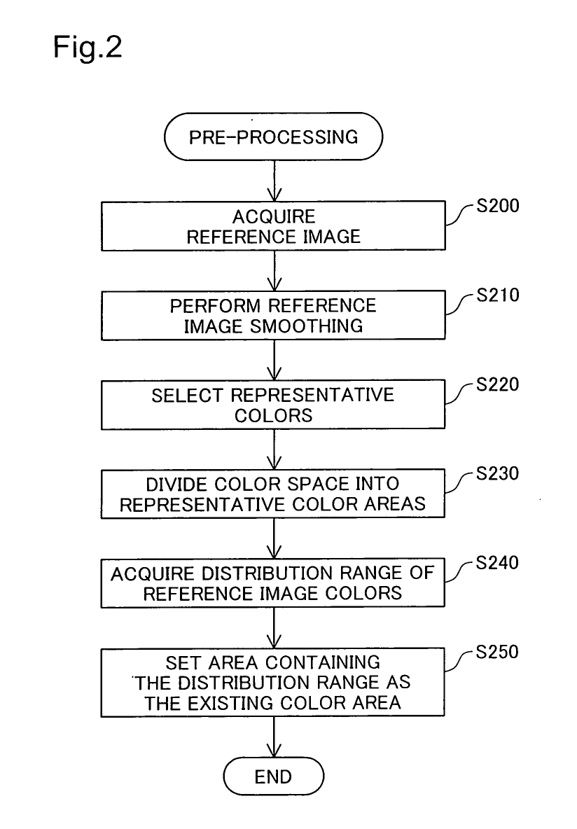

FIG. 2 is a flow chart showing the procedure for image processing (pre-processing) performed by the pre-processing unit for the first embodiment. At step S200, the reference image acquisition unit 220 (FIG. 1) acquires a color image of the printed circuit board PCB without a defect which is the reference image from the imaging unit 30 (FIG. 1). Note that when procedure after step S210 is executed with respect to an image acquired in advance, at step S200, image data is read from the external storage device 50 (FIG. 1).

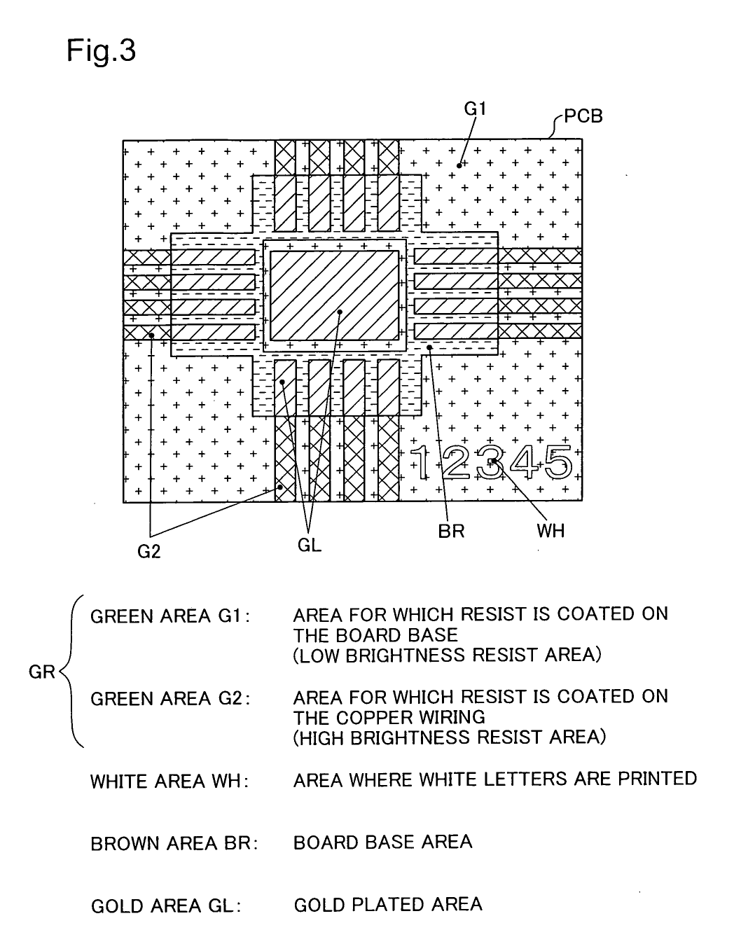

FIG. 3 depicts a color image of the printed circuit board PCB without defect acquired at step S200. The surface of the printed circuit board PCB comprises a first green area G1 for which resist is coated on the board base, a second green area G2 for which resist is coated on the copper wiring, and a white area WH for which white letters are silk printed onto the board base, a brown area BR of the board base, and a gold area GL which is gold plated. The board base which is the substrate of the first green area G1 is brown, and the copper wiring which is the substrate of the second green area G2 is copper colored, so the colors of these two areas G1 and G2 are slightly different, but they both have a green color in a sense. In light of this, with this embodiment, these two green areas G1 and G2 together are also called “green area GR.”

At step S210 (FIG. 2), the reference image acquisition unit 220 executes smoothing process (blurring process) on the reference image acquired at step S200. With the smoothing process, it is possible to use various smoothing filters such as median filter, a Gaussian filter, or a moving average filter. By performing this smoothing process, it is possible to remove a singular image existing within the image data, making it possible to obtain image data with little garbage (noise components). Note that this smoothing process may be omitted.

At step S220, the user sets a plurality of representative colors using a pointing device such as a mouse while observing the reference image displayed in the display unit of the computer 40. At this time, the representative color setting unit 210 (FIG. 1) displays a specified dialog box for representative color setting processing on the display unit of the computer 40, allowing the user to set the representative colors.

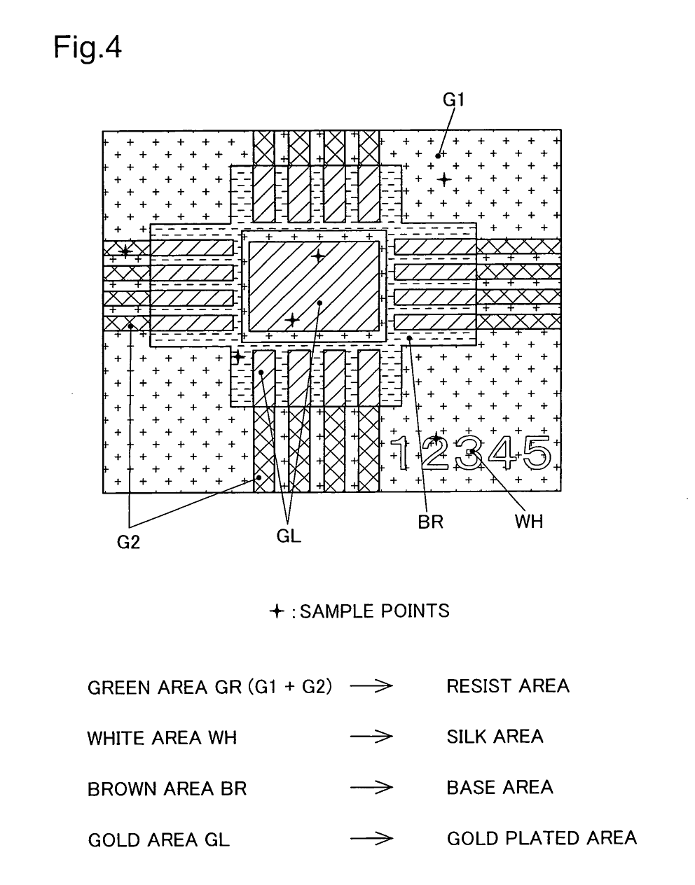

FIG. 4 illustrates the way of setting of the representative colors. The user inputs mnemonic names (e.g. “resist area,” “silk area,” etc.) of the four area types GR (G1+G2), WH, BR, and GL into the dialog box on the display screen, and specifies a sample point (indicated by a star mark) for acquiring a representative color of each area on the reference image. Sample points are specified at least one within each area. Note that when a plurality of sample points are specified in the same area, an average color of those sample points is used as a representative color for that area. It is also possible to use one or more points of the specified plurality of sample points to determine the representative color. Note that generally, both of the number of representative colors and the number of areas corresponding to the representative colors are set to N where N is an integer of 2 or greater.

At step S230 (FIG. 2), the representative color setting unit 210 divides the RGB color space into representative color areas corresponding respectively to the plurality of representative colors. In specific terms, the representative color setting unit 210 calculates a specified distance index value for representing a difference between each color point within the RGB color space (hereafter also called “individual color”) and the N color points of the representative colors. By classifying any individual color into one of N representative color areas for which the distance index value is a minimum among the N distance index values for the individual color, the RGB color space is divided into representative color areas.

The following type of indices may be used as the specified distance index value for the RGB color space, for example.

(1) An Euclidean distance between the point representing the individual color and the point representing the representative color, when the RGB color space is assumed as a three dimensional Euclidean space which has the RGB values as coordinates (hereafter called “Euclidean distance Deu”).

(2) An angle formed by a vector representing the individual color and a vector representing the representative color (hereafter also called “angle distance Dva”).

(3) A compound distance index value CDI obtained from these Euclidean distance Deu and angle distance Dva.

Note that with the first embodiment, the compound distance index value CDI is used as the specified distance index value. This composite distance index value CDI may be obtained using the following equations (1) or (2), for example, using the Euclidean distance Deu and the angle distance Dva.
CDI=Deu+Dva (1)
CDI=Deu*Dva (2)

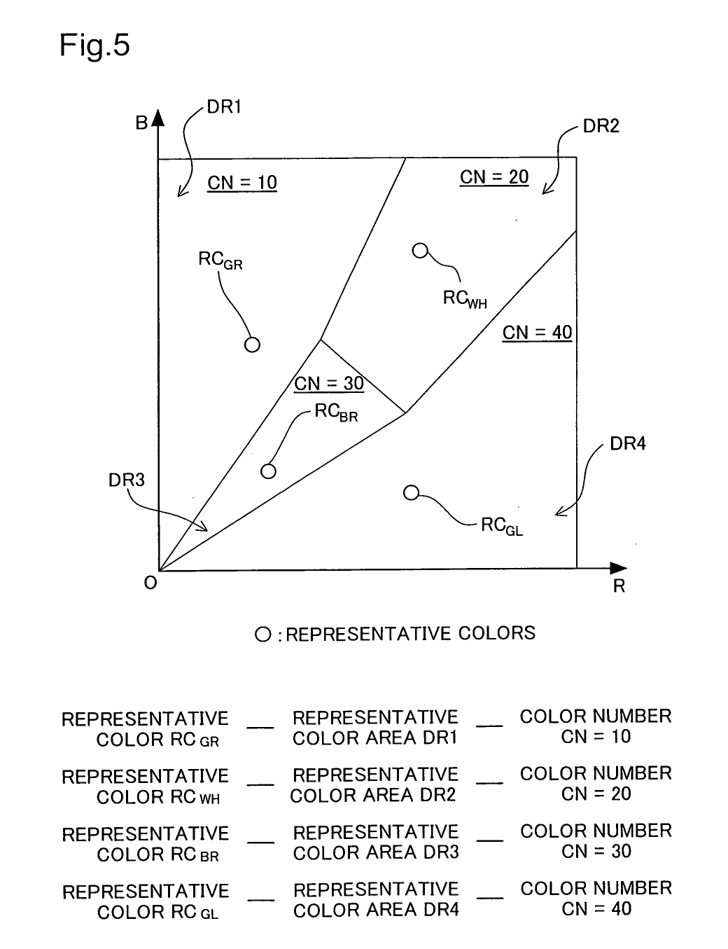

FIG. 5 illustrates the division result of a color space into representative color areas. With FIG. 5, for convenience of illustration, a point representing a representative color is depicted in a two dimensional color space (hereafter also called “R-B color space”) formed by the two color components of the R component and the B component. As described with FIG. 4, at step S220, four representative colors are set corresponding to the four types of the color areas, which are green area GR, the white area WH, the brown area BR, and the gold area GL. Therefore, in FIG. 5, the color space is divided into four representative color areas DR1 to DR4 corresponding to these four representative colors RC_{GR}, RC_{WH}, RC_{BR}, and RC_{GL}. More specifically, the color space is divided to these representative color areas DR1 to DR4 so that the composite distance index value CDI calculated between any color within each area and a representative color of that area is smaller than the composite distance index value CDI calculated between that any color and another representative color.

For the first embodiment, to store the division results of the color space into representative color areas, the representative color setting unit 210 generates a lookup table LUT for outputting a color number CN of 10 to 40 when the RGB value representing the individual color (also called an “input point”) is input. The generated lookup table LUT is saved in the external storage device 50. With this embodiment, as shown in FIG. 5, the color number CN is expressed as a two digit decimal number, and the tens digit is set to a value of 1 to 4 indicating which of the four representative color areas it belongs. Also, the ones digit is used as a flag indicating whether this is an “existing color” (described later).

Note that to reduce the capacity of the lookup table LUT, it is also possible to use a value for which one or more lower bits of the RGB values are omitted as the input points. In this case, of the individual colors, the colors for which only the omitted lower bits of the RGB value are different are treated as the same color and are allocated at the same input point.

At step S240 (FIG. 2), the existing color area setting unit 230 (FIG. 1) acquires a distribution range of the color that appears in the reference image (hereafter, such a color is also called “existing color”). In specific terms, the existing color area setting unit 230 acquires the color of each pixel of the reference image (hereafter also called the “reference pixel”). Then, the ones digit of the lookup table LUT output value which is the color number CN corresponding to the acquired reference pixel color is changed to 1. In this way, by rewriting the lookup table LUT, the color range for which the ones digit of the color number CN is 1 becomes the distribution range of the existing colors. Also, the color range for which the ones digit of the color number CN is 0 is the distribution range of non-existent colors.

At step S250, the existing color area setting unit 230 uses the area for which the existing color distribution range has undergone expansion processing (spreading process) as the existing color area. For example, for each input point of the lookup table LUT, when there is at least one existing color (color for which the ones digit of the corresponding color number CN is 1) at 8-neighbourhood of input point, the expansion process is performed by changing the ones digit of the color number CN corresponding to the input point to 1. With this expansion process, it is possible to include colors that are colors which may exist in the printed circuit board PCB without defects and which do not appear in the reference image in the existing color area.

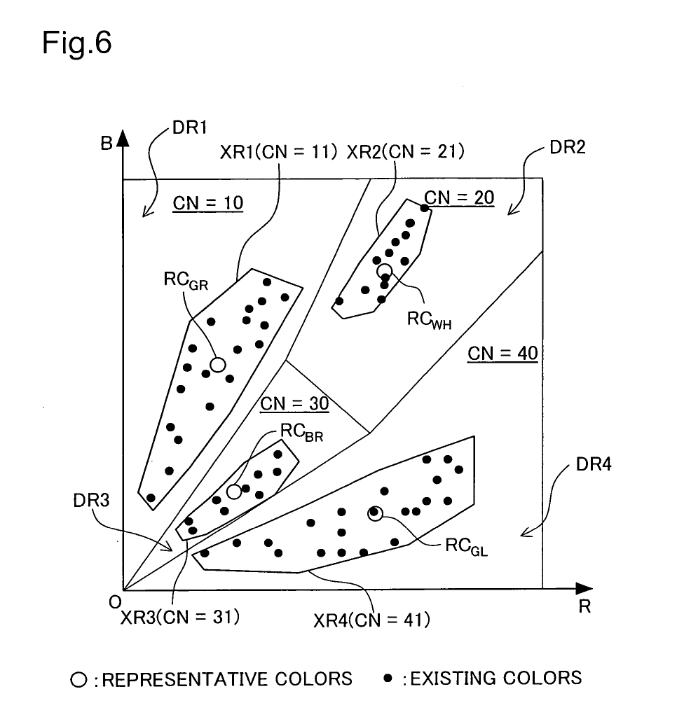

FIG. 6 illustrates the setting result of the existing color area for the first embodiment. The same as with FIG. 5, points representing representative colors in the RB color space are depicted as white circles. The black circles in FIG. 6 are points representing existing colors. Note that actual existing colors exist densely within the color space, but with FIG. 6, for convenience of illustration, a portion of the existing colors are depicted.

With the process of step S240 (FIG. 2), the color numbers CN corresponding to the existing colors within the representative color area DR1 corresponding to the representative color RC_{GR} are each set to 11. Then, with the expansion process of step S250 (FIG. 2), an existing color area XR1 including the existing colors within the representative color area DR1 is set. Similarly, the existing color areas XR2, XR3, and XR4 (CN=21, 31, 41) corresponding respectively to the representative colors RC_{WH}, RC_{BR}, and RC_{GL} are set to an area including the existing colors within the representative color areas DR2, DR3, and DR4.

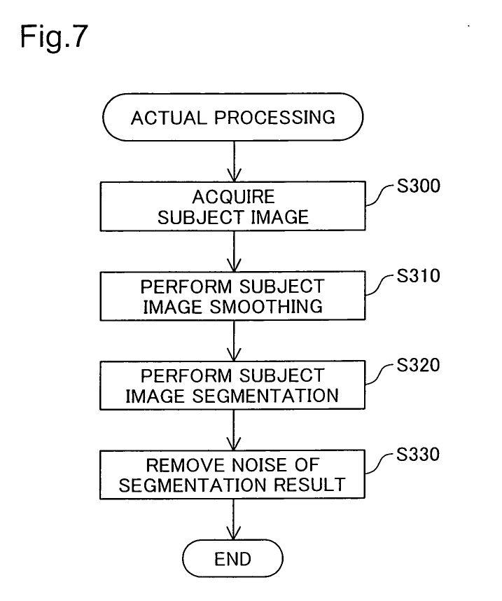

FIG. 7 is a flow chart showing the procedure of the image process (actual process) by the actual processing unit for the first embodiment. With this actual process, as with the pre-process shown in FIG. 2, the subject image acquisition unit 310 (FIG. 1) acquires the color image of the printed circuit board PCB subject to testing (also called the “subject image”) (S300), and performs smoothing process on the acquired subject image (S310).

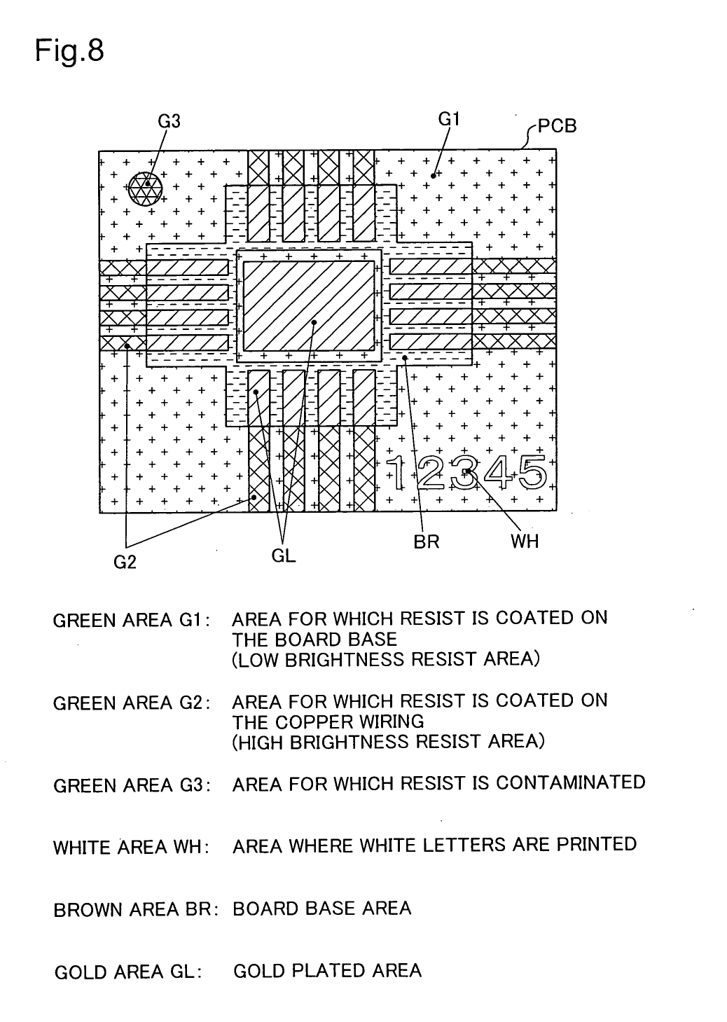

FIG. 8 depicts an example of the color image of the printed circuit board PCB with a defect acquired at step S300. The difference between this image and the image of the printed circuit board PCB without a defect (FIG. 3) is that there is an area G3 (also called an “abnormal area”) for which the resist on the upper left part of the printed circuit board PCB is contaminated. With the example in FIG. 8, the abnormal area G3 of the printed circuit board PCB for which resist contamination occurred is different from the green areas G1 and G2, but in fact is green colored.

At step S320 (FIG. 7), the subject image segmentation unit 320 (FIG. 1) classifies each pixel of the subject image (such a pixel is also called the “subject pixel”) that underwent smoothing process by assigning a color number CN to each subject pixel using the lookup table LUT. By classifying the subject pixels by the color number CN corresponding to the color of the subject pixel in this way, the subject image is divided into the areas of which number is less or equal to the number of color numbers set in advance (8 in the example in FIG. 6).

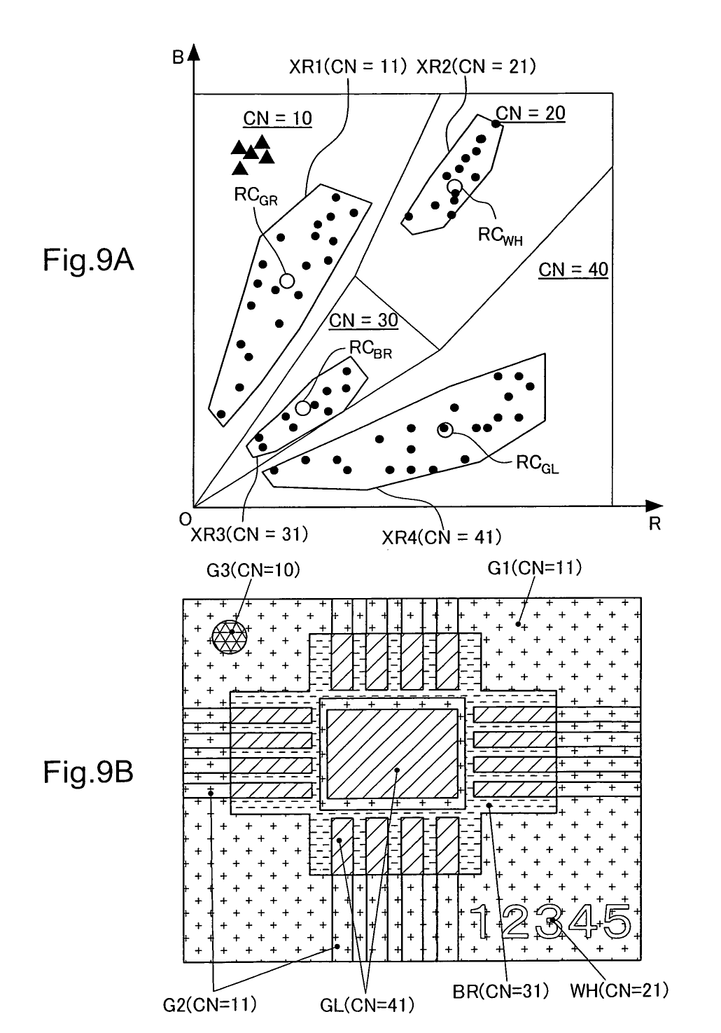

FIG. 9A illustrates distribution of color of pixels in the image of the printed circuit board PCB with a defect (FIG. 8). With FIG. 9A, as with FIG. 5, points representing representative colors for the R-B color space are depicted as white circles. Also, in FIG. 9A, the black circles represent colors that appear in the parts that are not the abnormal area, and the black triangles represent colors that do appear in the abnormal area.

As shown in FIG. 9A, colors that appear in the non-abnormal areas are included in the existing color areas XR1 to XR4 corresponding to the four representative colors RC_{GR}, RC_{WH}, RC_{BF}, and RC_{GL}. Because of this, the color numbers CN corresponding to the colors of the pixels of the non-abnormal areas have values indicating that they belong to the existing color areas XR1 to XR4 (CN=11, 21, 31, 41). Meanwhile, the colors of the abnormal area do not belong to the existing color areas, so the color numbers CN corresponding to the colors of the pixels of the abnormal area have values showing that they do not belong to the existing color areas (ones digit is 0). With the printed circuit board PCB in FIG. 8, the abnormal area color G3 is a green color belonging to the representative color area DR1, so the colors of the pixels of the abnormal area are correlated to color number CN=10.

FIG. 9B depicts segmentation result of the color image of the printed circuit board PCB shown in FIG. 8. As shown in FIG. 9B, the pixels in the subject image of the green area GR (G1+G2) where is coated with resist are classified into the color number CN=11 area for both cases. Similarly, the pixels of each area of the white area WH, the brown area BR, and the gold area GL are also classified into each area of color number CN=21, 31, and 41. Meanwhile, the pixels of the green area G3 for which the resist is contaminated are classified into the color number CN=10 area which is separate from the green area GR. In this way, by classifying each pixel of the subject image with the color number CN corresponding to the color of the pixel, the subject image is divided into five areas (CN=10, 11, 21, 31, and 41).

At step S330 (FIG. 7), the output generating unit 330 (FIG. 1) performs expansion processing and contraction processing on each area segmented in this way. By performing this expansion and contraction process, pinhole shaped small areas (noise) existing in each area of the segmented subject image are removed.

The segmentation results for which noise is removed are supplied to the testing unit (not illustrated) of the printed circuit board tester 100 (FIG. 1). The testing unit compares the reference image for which image processing is performed by the pre-processing unit and the segmented results obtained by the actual process unit. When there is a difference between the two images that is greater than the allowable value, the part that has such difference is detected as a defect of the printed circuit board PCB. With the example of the printed circuit board PCB of FIG. 8, the segmentation results shown in FIG. 9B are compared with the reference image shown in FIG. 3. Then, since there is a green area G3 that is not in the reference image in the segmentation results of FIG. 9B, it is determined that the printed circuit board PCB of FIG. 8 has a defect.

By performing segmentation of the subject image in this way, the area of the colors not assumed to appear during pre-processing (during representative color setting) of the color image may be separated from areas of colors belonging to the existing color areas (existing color image areas) as an area for colors not belonging to existing color areas (non-existent color image area). Because of this, it is possible to detect that the color assumed not to appear during pre-processing has appeared in the subject image, so it is possible to increase the reliability of the color image segmentation.

### B. Second Embodiment

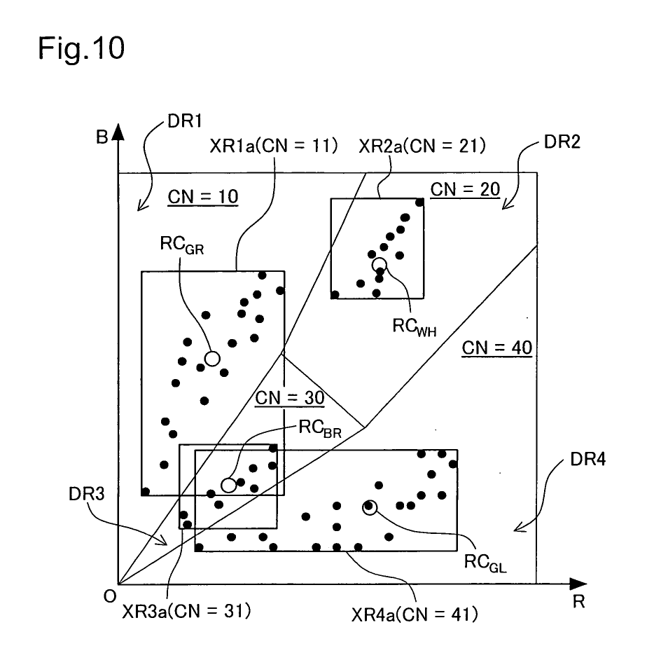

FIG. 10 illustrates the setting result of the existing color area for a second embodiment. With the second embodiment, each of the existing color areas is set as a range within maximum and minimum values of each color component. The maximum and minimum values are obtained from color component values of the existing colors which belong to each of the representative color areas. The existing color area of the second embodiment is different from the existing color area of the first embodiment shown in FIG. 6 in that regard.

The pre-processing of the second embodiment differs from the pre-processing of the first embodiment shown in the flow chart of FIG. 2 in that different processes are performed at steps S230 and S250. The other points are the same as the first embodiment. In the second embodiment as well, at step S230, the representative color setting unit 210 divides the RGB color space into representative color areas corresponding respectively to a plurality of representative colors. With the example in FIG. 10, the same as in FIG. 5, at step S230, the R-B color space is divided into four representative color areas DR1 to DR4 corresponding to the four representative colors RC_{GR}, RC_{WH}, RC_{BR}. and RC_{GL}. In contrast to the first embodiment, with the second embodiment, at step S230, generation and saving of the lookup table LUT for storing the result of color space division into these representative color areas are not executed.

At step S250 for setting the existing color areas, the existing color area setting unit 230 classifies the existing colors (color of each pixel of the reference image) to one of the representative color areas. With the example in FIG. 10, the same as in FIG. 6, the existing colors (indicated by black circles) are classified into one of the four representative color areas DR1 to DR4 that the R-B color space is divided into. Note that it is possible to determine to which representative color area each existing color belongs by evaluating the positional relationship between the border of the representative color areas and color point of the existing color.

After the classification of the existing colors into representative color areas, the existing color area setting unit 230 obtains the maximum and minimum values of each color component of the existing colors which belong to each of the representative color area. Then, the existing color area corresponding to each representative color is set as an area for which value of each color component is within the range of the maximum and minimum values. With the example in FIG. 10, the area for which both of R component value and B component value are within the ranges of the maximum and minimum values of the existing colors belonging to the representative color area DR1 becomes a rectangular area XR1a. In this way, the existing color area corresponding to the representative color RC_{GR} is set as the rectangular area XR1a. Similarly, the existing color areas corresponding to the representative colors RC_{WH}, RC_{BR}, and RC_{GL} are respectively set to areas XR2a, XR3a, and XR4a.

The existing color areas XR1a to XR4a set in this way are stored in the external storage device 50 (FIG. 1) together with the color component values of the representative colors RC_{WH}, RC_{BR}, and RC_{GL} as the maximum and minimum values of each color component associated respectively to the representative color areas DR1 to DR4, for example.

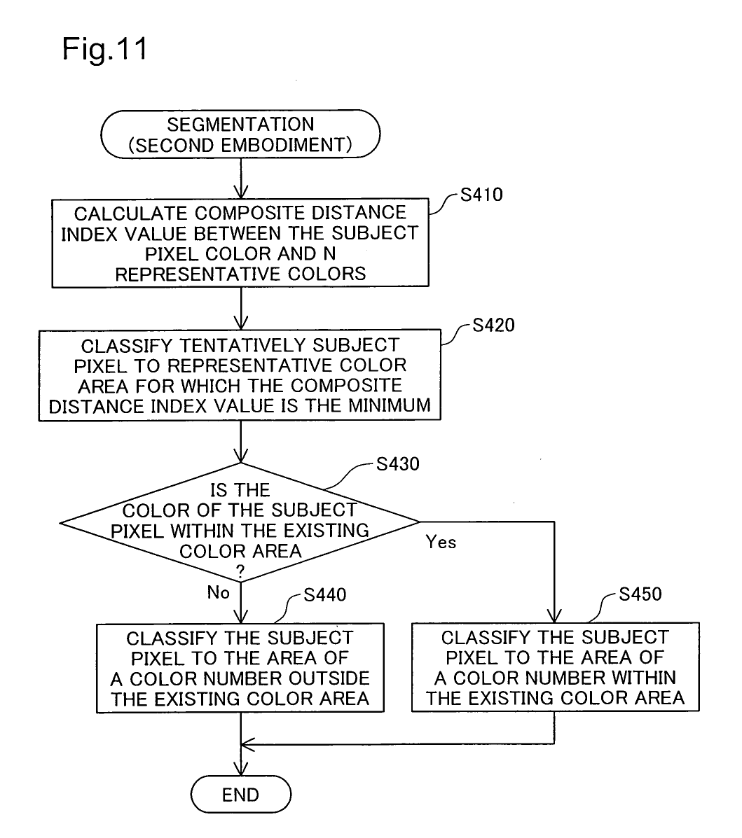

FIG. 11 is a flow chart showing the procedure of segmentation for the second embodiment. This segmentation procedure differs from the segmentation (S320) of the first embodiment shown in FIG. 7 in that the segmentation is performed without using the lookup table LUT. The other procedures of the actual processing of the second embodiment are the same as the procedures of the first embodiment shown in FIG. 7.

At step S410, the subject image segmentation unit 320 (FIG. 1) calculates the composite distance index value CDI between each of the subject pixel colors and the N representative color points. Then, at step S420, of the calculated N composite distance index values CDI, the subject pixels are tentatively classified to one of the representative color areas for which the representative color has the minimum composite distance index value CDI. With this tentative classification, the color number CN for which the ones digit is 0, indicating that color of the subject pixel is outside the existing color area is assigned to the subject pixel. With the example of FIG. 10, the color numbers assigned to the subject pixels are one of color numbers 10, 20, 30, and 40 which are corresponding to the four representative numbers. This tentative classification and the setting of the representative color area for the pre-processing are performed according to the same composite distance index value CDI. As a result, tentatively classified result of any color point in the color space coincides to the representative color areas at the pre-processing.

At step S430, the subject image segmentation unit 320 determines whether the color of the subject pixel is within the existing color area. In specific terms, the subject image segmentation unit 320 determines whether the color component values of the subject pixel is within the ranges, which are corresponding to the representative color area to which the subject pixel color belongs, of the maximum and minimum values of each color component. When it is determined that the subject pixel color is not within the existing color area, the control moves to step S440. Meanwhile, when the subject pixel color component value is within the existing color area, the subject pixel color is determined to be within the existing color area, and the control moves to step S450.

At step S440, the subject image segmentation unit 320 classifies the subject pixels into color number CN areas of the non-existent color area. In specific terms, the ones digit of the color number CN tentatively assigned at step S420 is set to 0. Note that in the case of the second embodiment, the tentatively assigned color number CN has an ones digit of 0, so no processing is performed at step S440. With the example in FIG. 10, when the subject pixel color belongs to the representative color area DR1, the subject pixel is classified into the area for which the color number CN=10. Similarly, when the subject pixel colors belong to the representative color areas DR2, DR3, and DR4 in the existing color areas, the subject pixels are classified in the areas for which the color number CN=20, 30, and 40.

At step S450, the subject image segmentation unit 320 classifies the subject pixels into color number CN areas of the existing color area. In specific terms, the ones digit of the color number CN tentatively assigned at step S420 is set to 1. With the example in FIG. 10, when the subject pixel colors belongs to the representative color area DR1, the subject pixel are classified in the area for which the color number CN=11. Similarly, when the subject pixel colors belong to the representative color areas DR2, DR3, and DR4, the subject pixels are classified as areas for which the color number CN=21, 31, and 41 respectively.

In this way, with the second embodiment as well, areas of the color image of colors not expected to appear during pre-processing may be separated from the existing color image areas as non-existent color image areas. Because of this, it is possible to detect when colors not expected to appear during pre-processing appear in the subject image, so it is possible to increase the reliability of the area segmentation of the color image.

With the second embodiment, the existing color areas set by the pre-processing unit are represented by the maximum and minimum values of each color components corresponding to the representative color areas. In contrast to the first embodiment that uses the lookup table LUT, it is possible to reduce the capacity of the storage areas for storing the setting of the existing color areas. Meanwhile, the first embodiment does not perform distance index value calculation for each subject pixel during actual processing, so it is possible to accelerate the actual processing.

Note that with the second embodiment, the existing color area for each representative color area is set to the area within the range of the maximum and minimum values for each color components of existing colors which is classified to the corresponding representative color area. The existing color area also can be set as long as the color component value range can be specified. For example, it is also possible to set the existing color area when a color that does not belong in the preset existing color area appears in the reference pixels, an existing color area to which the appeared color belongs is selected based on user's instruction, and the selected existing color area is expanded so that the appeared color belongs to the expanded area. In this case, it is preferable to have an area that is sufficiently small as the initially set existing color area. As this kind of sufficiently small area, it is possible to use an area containing only representative color points, for example.

### C. Third Embodiment

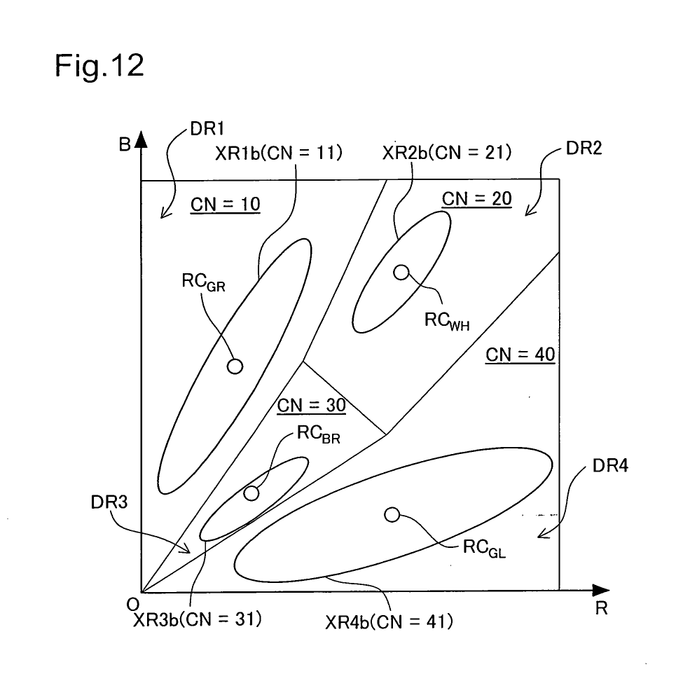

FIG. 12 illustrates the setting result of the existing color area for a third embodiment. As with FIG. 6, FIG. 12 shows the division result of the RB color space into the four representative color areas DR1 to DR4 corresponding to the four representative colors RC_{GR}, RC_{WH}, RC_{BR}, and RC_{GL}.

In the third embodiment, of the procedures of the pre-processing of FIG. 2, step S240 for acquiring a distribution range for the reference image colors may be omitted. Then, at step S250, the existing color area setting unit 230 (FIG. 1) sets a limit value (hereafter called “distance limit value”) of the composite distance index value CDI with the corresponding representative colors RC_{GR}, RC_{WH}, RC_{BR}, and RC_{GL} for each representative color area DR1 to DR4. The existing color areas of the third embodiment are set to areas XR1b to XR4b for which the composite distance index value CDI for the representative colors RC_{BR}, RC_{WH}, RC_{BR}, and RC_{GL} is the distance limit value or less. The existing color areas XR1b to XR4b set in this way are stored in the external storage device 50 (FIG. 1) together with the representative colors RC_{WH}, RC_{BR}, and RC_{GL} with a distance limit value correlated respectively to the representative color areas DR1 to DR4, for example.

Note that the distance limit value that stipulates the existing color areas XR1b to XR4b may be determined based on the color dispersion of a plurality of selected sample points when setting the representative colors (S220 (FIG. 2)) or on values (e.g. brightness or saturation) relating to the color of the representative colors RC_{GR}, RC_{WH}, RC_{BR}, and RC_{GL}. It is also possible to display a dialog box for the user to specify a distance limit value, and to use the distance limit value specified by the user.

For the third embodiment, the segmentation is performed in the same manner as the second embodiment shown in FIG. 11. In this case, whether the subject pixel colors are within the existing color area at step S324 is determined by deciding whether the representative color of the representative color area to which the subject pixel color belongs and the subject pixel color composite distance index value CDI index is within a specified value.

In this way, with the third embodiment as well, areas of the color image for which a color not expected to appear during pre-processing may be separated from the existing color image areas as a non-existent color image area. Because of this, it is possible to detect that a color that not expected to appear during pre-processing appeared in the subject image, so it is possible to increase the reliability of the color image area division.

Similarly to the second embodiment, with the third embodiment, the existing color area set by the pre-processing unit is represented by a distance limit value correlated to a representative color area. In contrast to the first embodiment that uses the lookup table LUT, it is possible to decrease the capacity of the storage area for storing the setting of the existing color areas. Meanwhile, with the second embodiment, the existing color areas are set based on the distribution range of the reference pixel color, so setting the existing color area is easier than with the third embodiment.

Note that with the third embodiment, the pre-processing step S240 (FIG. 2) may be omitted, and the existing color areas XR1b to XR4b are set separately from the reference pixel color distribution range, but it is also possible to have the existing color area setting unit 230 acquire the reference pixel colors at step S240, and to set the distance limit value so that all the reference pixel colors belong to one of the existing color areas XR1b to XR4b.

### D. Fourth Embodiment

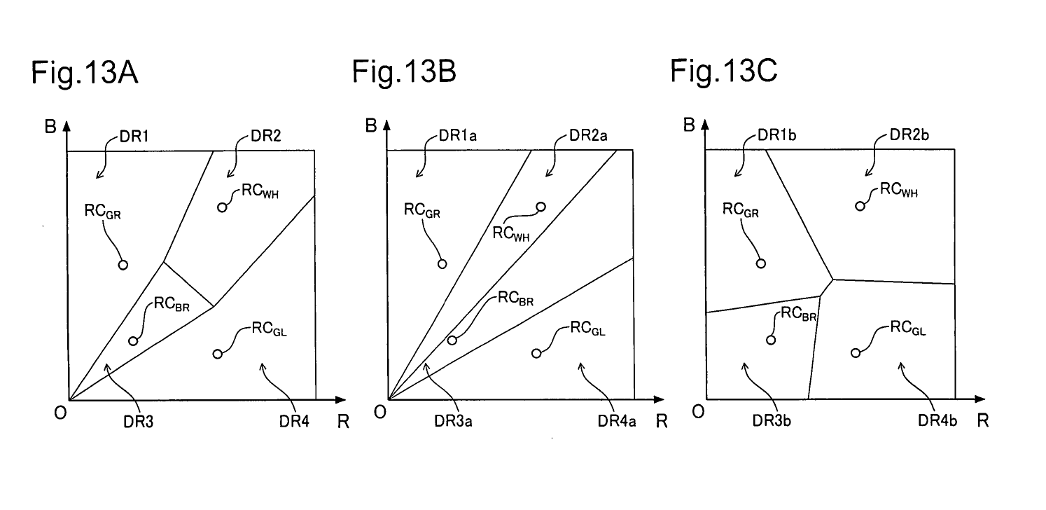

FIG. 13A through FIG. 13C illustrate the division results of a color space into representative color areas used for setting of the existing color areas for a fourth embodiment. In the fourth embodiment, the existing color areas are set using the composite distance index value CDI and a different distance index value from the composite distance index value CDI. Note that with the fourth embodiment, similarly to the third embodiment, the existing color areas are set individually from the distribution range of the reference pixel colors. Because of this, of the procedures of the pre-processing of FIG. 2, step S240 for acquiring the distribution range of the reference pixel colors may be omitted.

With the fourth embodiment, at the pre-processing step S230 shown in FIG. 2, the existing color area setting unit 230 (FIG. 1) divides the RGB color space into representative color areas based on the distance index values of the composite distance index value CDI, the angle distance Dva, and the Euclidean distance Deu. FIG. 13A, the same as FIG. 5, shows the result of the R-B color space division into the four representative color areas DR1 to DR4 based on the composite distance index value CDI. FIG. 13B and FIG. 13C show the result of the R-B color space division into the for representative color areas DR1a to DR4a and DR1b to DR4b, where the division of the color space is performed based on the angle distance Dva and the Euclidean distance Deu respectively.

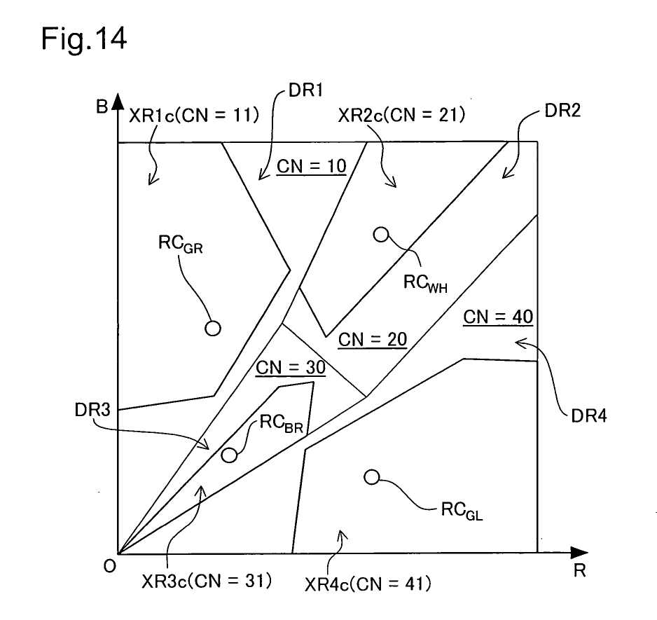

FIG. 14 illustrates the setting result of the existing color areas using the three divided results of a color space shown in FIG. 13A through FIG. 13C. With the fourth embodiment, at the pre-processing step S260 shown in FIG. 2, the existing color area setting unit 230 sets the area XR1c that is shared by the three types of representative color area DR1, DR1a, and DR1b in relation to the representative color RC_{GR} as the existing color area. The other existing color areas corresponding to the representative colors RC_{WH}, RC_{BR}, and RC_{GL} are similarly set. To store the existing color areas XR1c to XR4c set in this way and the results of dividing to the representative color areas DR1 to DR4, the existing color area setting unit 230 generates the lookup table LUT for outputting color numbers CN assigned appropriately for each individual color in the color space and stores this in the external storage device 50 (FIG. 1).

With the actual processing of the fourth embodiment, the same as with the actual processing of the first embodiment, the subject image segmentation unit 320 (FIG. 1) performs segmentation of the subject image by assigning a color number CN to each subject pixel using the lookup table LUT.

With the fourth embodiment as well, the areas of colors not expected to appear during pre-processing of the color image may be separated from the existing color image areas as non-existent color image areas. Because of this, it is possible to detect that a color not expected to appear during pre-processing has appeared in the subject image, allowing an increase in the reliability of color image area division.

Note that with the fourth embodiment, as the plurality of distance index values for setting the existing color areas, three distance index values of the composite distance index value CDI, the angle distance Dva, and the Euclidean distance Deu are used, but generally, it is possible to use any plurality of two or more distance index values correlated to the distance between colors.

### E. Fifth Embodiment

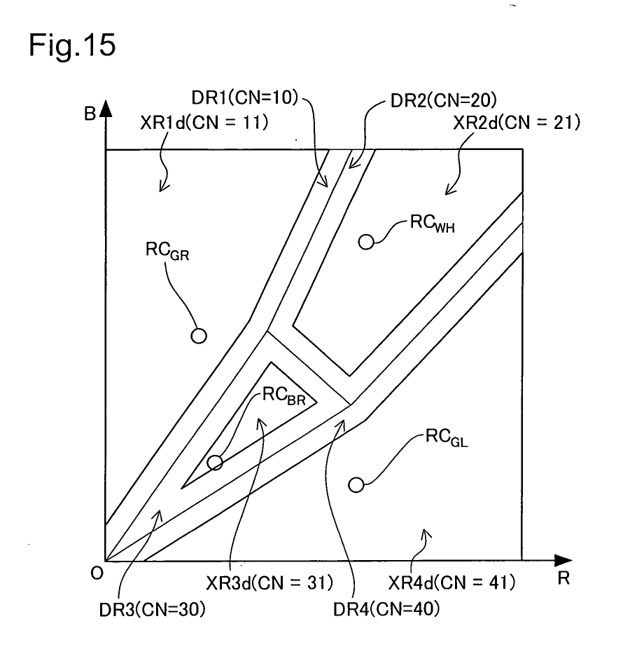

FIG. 15 illustrates the setting result of the existing color area for a fifth embodiment. Of the representative color areas DR1 to DR4 divided in the same way as the first embodiment shown in FIG. 5, the existing color areas in the fifth embodiment are set to the areas XR1d to XR4d for which areas for which representative color areas are in mutual contact are removed.

This kind of existing color areas XR1d to XR4d may be acquired by performing contraction processing respectively on the representative color areas DR1 to DR4. In specific terms, the same as with the first embodiment, the color space is divided into the representative color areas DR1 to DR4, and the lookup table LUT for maintaining those division results is created. Then, contraction processing is performed on each of the representative color areas DR1 to DR4 of the generated lookup table LUT. With this contraction processing, the existing color area XR1d is generated from the representative color area DR1. Similarly, the existing color areas XR2d to XR4d are acquired from the representative color areas DR2 to DR4.

This contraction processing may be performed by specifying two color components of the plurality of color components of the input points of the lookup table LUT, for example. When a color component other than the specified color components is fixed, the representative color area that appears in the two dimensional color space formed from the specified color components forms a two dimensional image. By performing known contraction processing on the two dimensional images representing the representative color areas for each of the color component values which can be taken from the color components other than the specified color components, it is possible to perform contraction processing on the representative color areas.

With the actual processing of the fifth embodiment as well, as with the actual processing of the first embodiment, the subject image segmentation unit 320 (FIG. 1) performs segmentation of the subject image by assigning a color number CN to each subject pixel using the lookup table LUT.

With the fifth embodiment as well, the areas of colors not expected to appear during pre-processing of the color image may be separated from the existing color image areas as non-existent color image areas. Because of this, it is possible to detect that a color not expected to appear during pre-processing appeared in the subject image, allowing an increase in the reliability of the color image segmentation.

### F. Sixth Embodiment

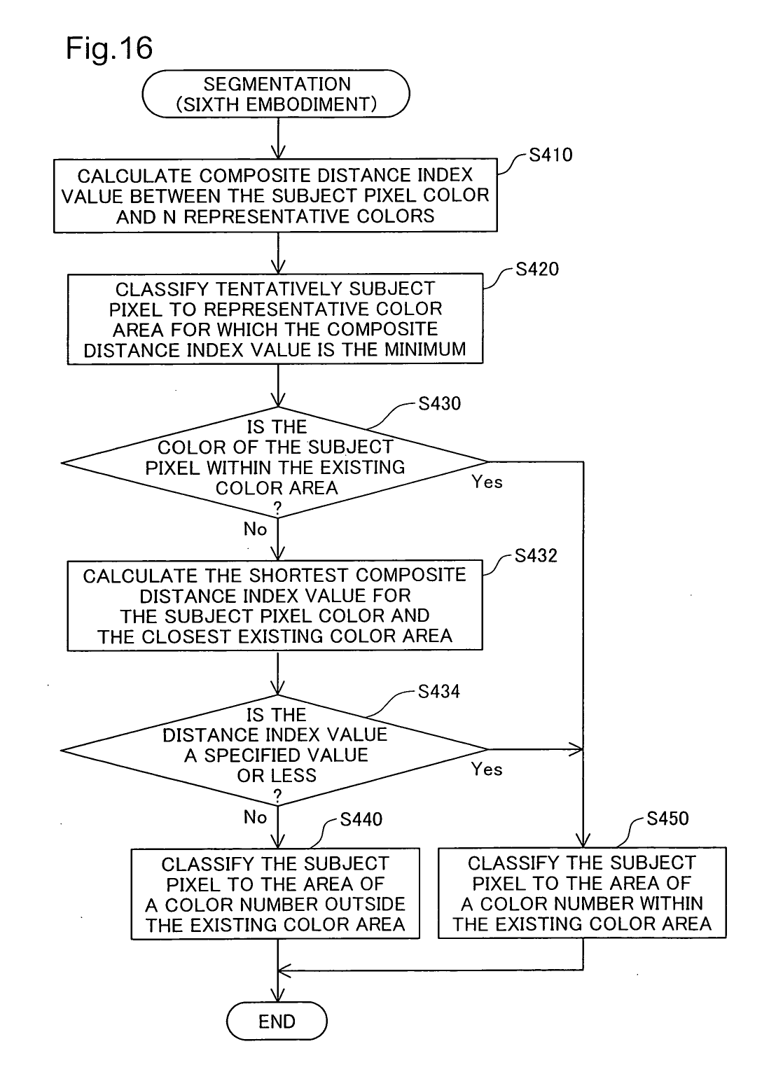

FIG. 16 is a flow chart showing the procedure for segmentation for the sixth embodiment. This differs from the area division procedure of the second embodiment shown in FIG. 11 in that two steps S432 and S434 are added between steps S430 and S440.

For the sixth embodiment, when it is determined that the subject pixel color is not within the existing color area at step S430, the control moves to step S432. At step S432, the existing color area closest to the subject pixel color (nearest existing color area) is selected by the subject image segmentation unit 320 (FIG. 1). Then, the shortest composite distance index value CDI (shortest distance) between the subject pixel color and the nearest existing color area is calculated. Note that as a nearest existing color area, it is possible to select the existing color area for which the composite distance index value CDI is the smallest between the representative colors corresponding to each of the plurality of existing color areas and the subject pixel color, for example.

At step S434, the subject image segmentation unit 320 determines whether the subject pixel color belongs to the existing color area based on the shortest distance obtained at step S432. When the shortest distance is greater than a specified value, the subject pixel color is determined to be outside the existing color area, and the control moves to step S440. Meanwhile, when the shortest distance is the specified value or less, the subject pixel color is determined to be within the existing color area, and the control moves to step S450. Note that for the specified value for determining whether a color belongs to the existing color area, it is possible to use the variation width of colors represented by the composite distance index value that appears between the plurality of images for which the same printed circuit board PCB is acquired by imaging, for example.

In this way, with the sixth embodiment, it is possible to suppress the affection of change in color that occurs during image acquisition, so it is possible to perform determination of whether the subject pixel color belongs to the existing color area more accurately.

With the sixth embodiment, the procedure for determining whether an area is an existing color area based on the shortest distance between the subject pixel color and the nearest existing color area is added to the second embodiment. This procedure may also be used in cases of the other embodiments.

Also, with the sixth embodiment, the composite distance index value CDI is used for calculation of the shortest distance between the subject pixel color and the nearest existing color area. In general it is possible to use any distance index value correlated to the distance between colors. In this case, as the shortest distance, it is also possible to use the angle distance Dva or the Euclidean distance Deu, for example.

### G. Modifications

The present invention is not limited to the aforementioned embodiments and working examples, and may be reduced to practice in various other modes without departing from the scope and spirit thereof, such as the following modifications, for example.

### G1. Modification 1

With the second and third embodiments hereinabove, segmentation is performed without using the lookup table LUT, but it is also possible to perform segmentation using the lookup table LUT the same way as in the first embodiment. In this case, it is determined whether each input point belongs to the existing color area at the pre-processing stage. When the input point is within the existing color area, the output value of the lookup table LUT is set to the color number of the existing color area of which ones digit is 1, and when the input point is outside the existing color area, the output value of the lookup table LUT is set to the color number of which ones digit is 0 for indicating that the input point is outside the existing color area.

### G2. Modification 2

With each of the embodiment hereinabove, the color number CN of the representative color area is assigned for each of the non-existent color areas as well, but it is also possible to assign one same color number CN to all the colors of the non-existent color area for indicating that the colors are non-existent colors. In this way as well, it is possible to separate the areas of colors not expected to appear during pre-processing of the color image from the existing color image areas as non-existent color image areas.

### G3. Modification 3

With each of the embodiment hereinabove, whether a color belongs to the existing color area is indicated by the ones digit of the color number CN, but it is also possible to represent whether a color belongs to the existing color area using various other methods as well. For example, it is possible to indicating whether a color belongs to the existing color area is represent this by whether a part of a bit sequence representing the color number CN is on or off, or by whether a flag set separately from the color number CN is on or off.

### G4. Modification 4

With each of the embodiment hereinabove, pixel color of the reference image and the subject image is represented by the RGB three dimensional color space, but it is also possible to represent the pixel color by other various types of color spaces. For example, it is possible to represent the pixel color by another three dimensional color space such as the L*a*b* color space, or by a two dimensional color space determined only by two basic colors, etc. Specifically, the present invention generally can be applied for the color image of which pixel color is represented by color spaces of two dimensions or more.

### G5. Modification 5

With each of the embodiment hereinabove, the existing color areas are decided according to representative colors and representative color areas, but it is also possible to set the existing color areas without using representative colors and representative color areas. This kind of existing color area may be set according to instructions from the user. It is possible to set the existing color area by displaying a color palette for the user to specify colors included in the existing color area. In this case, it is possible to omit calculation of the distance index values.

### G6. Modification 6

With each of the embodiment hereinabove, the testing unit of printed circuit board tester 100 (FIG. 1) detects a defect of the printed circuit board PCB by comparing segmented result of the subject image and reference image. However, in general, the defect of the printed circuit board PCB may be detected in accordance only with the segmented result. For example, when the segmented result of the subject image indicates existence of color belongs to non-existing color area, the testing unit may decide that the printed circuit board PCB has a defect.

### G7. Modification 7

With each of the embodiment hereinabove, color image segmentation technique of the present invention is applied to the inspection of printed circuit board. However, the color image segmentation technique of the present invention is applicable for inspection of any object subject to testing of which defect appears as change in surface color. The present invention is applicable for inspection method or inspection method, which detects a defect of object subject to testing such as a semiconductor wafer, a glass substrate, a film and a printed matter, by using color image obtained by imaging the object subject to testing.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of a subject image segmentation wherein the subject image is a color image obtained by imaging a colored object with possibility of change in color for each individual item, the method comprising the steps of:
(a) setting N existing color areas indicating ranges of N colors containable in the subject image when the colored object has an allowable range of color, and a non-existent color area outside the N existing color areas, within a specified color space, N being an integer of 2 or more; and
(b) dividing the subject image into areas by classifying colors of subject pixels that form the subject image obtained by imaging each of the colored object into the N existing color areas and the non-existent color area.

2. A method according to claim 1, wherein the step (a) includes the steps of:
(1) providing at least one reference image which is a standard color image of the colored object;
(2) setting N representative colors from a plurality of colors included in the reference image;
(3) dividing the specified color space into N representative color areas corresponding to the N representative colors in accordance with a specified distance index value correlated to a distance between any color of the specified color space and the N representative colors; and
(4) setting the N existing color areas including the N representative colors within the N representative color areas, and setting an area other than the N existing color areas as the non-existent color area.

3. A method according to claim 2, wherein the step (4) has the step of classifying colors of reference pixels which form the reference image into the N representative color areas, and setting partial areas of the N representative color areas which contain the colors of the reference pixels as the N existing color areas.

4. A method according to claim 2, wherein the step (4) has the step of setting, as the N existing color areas, N areas which are constituted of colors whose distance index value associated with the N representative colors is less than a specified value.

5. A method according to claim 2, wherein the step (4) has the steps of
setting plural sets of the N representative color areas by using a plurality of mutually different types of distance index values as the distance index value; and
finding with respect to each representative color a shared area shared by corresponding representative color areas in the plural sets which have the same representative color, and setting a plurality of the shared areas as the N representative color areas.

6. A method according to claim 2, wherein the step (4) has the step of deleting from each of the N representative color areas a border area between the representative color area and other representative color areas to obtain a residual area with respect to each representative color area, and setting the residual areas as the existing color areas.

7. A method according to claim 2, wherein the step (b) includes the step of classifying color of the subject pixel belonging to the non-existent color area into a closest existing color area which is selected from the N existing color areas and which has a color closest to the color of the subject pixel, when the index value representing the distance between a color of the closest existing color area and the color of the subject pixel is less than a specified value.

8. A method according to claim 1, wherein
the step (a) includes the step of generating a lookup table for inputting any color within the specified color space, and for outputting values indicating which of the N existing color areas and the non-existent color area the any color belongs to, and
the step (b) includes a step of referencing the lookup table and executing the area division.

9. A method according to claim 8, wherein the step (a) includes the steps of:
(1) providing at least one reference image which is a standard color image of the colored object;
(2) setting N representative colors from a plurality of colors included in the reference image;
(3) dividing the specified color space into N representative color areas corresponding to the N representative colors in accordance with a specified distance index value correlated to a distance between any color of the specified color space and the N representative colors; and
(4) setting the N existing color areas including the N representative colors within the N representative color areas, and setting an area other than the N existing color areas as the non-existent color area.

10. A method according to claim 9, wherein the step (4) has the step of classifying colors of reference pixels which form the reference image into the N representative color areas, and setting partial areas of the N representative color areas which contain the colors of the reference pixels as the N existing color areas.

11. A method according to claim 9, wherein the step (4) has the step of setting, as the N existing color areas, N areas which are constituted of colors whose distance index value associated with the N representative colors is less than a specified value.

12. A method according to claim 9, wherein the step (4) has the steps of:
setting plural sets of the N representative color areas by using a plurality of mutually different types of distance index values as the distance index value; and
finding with respect to each representative color a shared area shared by corresponding representative color areas in the plural sets which have the same representative color, and setting a plurality of the shared areas as the N representative color areas.

13. A method according to claim 9, wherein the step (4) has the step of deleting from each of the N representative color areas a border area between the representative color area and other representative color areas to obtain a residual area with respect to each representative color area, and setting the residual areas as the existing color areas.

14. A method according to claim 9, wherein the step (b) includes the step of classifying color of the subject pixel belonging to the non-existent color area into a closest existing color area which is selected from the N existing color areas and which has a color closest to the color of the subject pixel, when the index value representing the distance between a color of the closest existing color area and the color of the subject pixel is less than a specified value.

15. An apparatus of a subject image segmentation wherein the subject image is a color image obtained by imaging a colored object with possibility of change in color for each individual item, the apparatus comprising:
an existing color area setting unit configured to set N existing color areas indicating ranges of N colors containable in the subject image when the colored object has an allowable range of color, and a non-existent color area outside the N existing color areas, within a specified color space, N being an integer of 2 or more; and
a segmentation executing unit configured to divide the subject image into areas by classifying colors of subject pixels that form the subject image obtained by imaging each of the colored object into the N existing color areas and the non-existent color area.

16. A method of inspecting a test object of which a defect appears as change in surface color of the test object using a subject image wherein the subject image is a color image obtained by imaging the test object having possibility of change in color for each individual item, the method comprising the steps of:
setting N existing color areas indicating ranges of N colors containable in the subject image when the test object has an allowable range of color, and a non-existent color area outside the N existing color areas, within a specified color space, N being an integer of 2 or more;
dividing the subject image into areas by classifying colors of subject pixels that form the subject image obtained by imaging each of the test object into the N existing color areas and the non-existent color area; and
detecting the defect of the test object according to a divided result of the subject image.

17. An apparatus of inspecting a test object of which a defect appears as change in surface color of the test object using a subject image wherein the subject image is a color image obtained by imaging the test object having possibility of change in color for each individual item, the apparatus comprising:
an existing color area setting unit configured to set N existing color areas indicating ranges of N colors containable in the subject image when the test object has an allowable range of color, and a non-existent color area outside the N existing color areas, within a specified color space, N being an integer of 2 or more;
a segmentation executing unit configured to divide the subject image into areas by classifying colors of subject pixels that form the subject image obtained by imaging each of the test object into the N existing color areas and the non-existent color area; and
a testing unit configured to detect the defect of the test object according to a divided result of the subject image.
